(19) United States
(12) Patent Application Publication
(10) Pub. No.: US 2007/0149407 A1
(43) Pub. Date: Jun. 28, 2007

(54) Aqueous suspension concentrates

(75) Inventors: Gerhard Frisch, Wehrheim (DE); Ulrike Ebersold, Hattersheim (DE); Janine Rude, Kriftel (DE)

Correspondence Address: CONNOLLY BOVE LODGE & HUTZ, LLP, P O BOX 2207, WILMINGTON, DE, 19899, US

(73) Assignee: Bayer CropScience GmbH, Frankfurt am Main (DE)

(21) Appl. No.: 11/603,605

(22) Filed: Nov. 22, 2006

(30) Foreign Application Priority Data
Nov. 25, 2005 (EP) 05025746.1

(51) Int. Cl. A01N 43/56; A01N 25/02

(52) U.S. Cl. 504/281; 504/362

(57) ABSTRACT

The invention relates to aqueous suspension concentrates, comprising (1) one or more active ingredients from the group of the 4-Benzoylpyrazoles, (2) one or more surfactants based on substituted phenol ethers, (3) one or more thickeners based on aluminum silicate, and (4) if desired, additional formulating assistants, and also (5) if desired, additional surfactants, different from component (2). As well as the high-concentration formulating of active ingredients, this may make it possible to achieve a better biological action at a given application rate.

The invention pertains to the technical field of formulations of active ingredients.

There are many different ways in which in principle active ingredients can be formulated, with possible problems arising from the properties of the active ingredients and the nature of the formulation and affecting the ease of preparation, stability, ease of application and activity of the formulations. Moreover, there are economic and environmental reasons why certain formulations are more advantageous than others.

The active ingredients from the group of the 4-benzoylpyrazoles, as described in WO-A-01/74785, are highly active herbicides which act against weed plants in plant crops. With a view to the formulation of these active ingredients, WO-A-01/74785 already cites a number of potentially possible formulation types, such as wettable powders (WP), water-soluble powders (SP), water-soluble concentrates, emulsifiable concentrates (EC), emulsions (EW), such as oil-in water and water-in oil emulsions, sprayable solutions, suspension concentrates (SC), oil- or water-based dispersions, oil-miscible solutions, capsule suspensions (CS), dusts (DP), seed dressing products, granules for spreading and for soil application, granules (GR) in the form of microgranules, spray granules, coated granules and adsorption granules, water-dispersible granules (WG), water-soluble granules (SG), ULV formulations, microcapsules, and waxes, although specific formulating examples have been set out only for dusts, dispersible powder, dispersion concentrate, emulsifiable concentrate and water-dispersible granules.

Besides these standard formulations, there exists generally a need for suitable specific formulations of active ingredients that can be used to achieve a better biological action at a given application rate.

There is also a need for highly concentrated formulations of active ingredients, since it entails a number of advantages. For example, the packaging required is less, and less complex, than with low-concentration formulations. Accordingly the cost and complexity of production, transport and storage are reduced; in addition, for example, the preparation of the spray mixtures used in agriculture is simplified as a result of the smaller quantities of crop protection composition, for example, that have to be handled, as during operations of dispensing and stirring, for example.

Water-based formulations generally have the advantage of requiring a small proportion, or none at all, of organic solvents.

Aqueous suspension concentrates for formulating active ingredients, from the sectors of agrochemicals, pharmaceuticals, veterinary medicine, and also paints and varnishes, are known. EP-A-0110174, for example, describes aqueous suspension concentrates of crop protection products, and there are also descriptions of relatively high-concentration aqueous suspension concentrates, such as of sulfur in EP-A-0220655 and of Metamitron in EP-A-0620971. There a mixture of formaldehyde condensation products or ligninsulfonates, respectively and wetting agent is used with preference.

The object, then, was to provide formulations which exhibit advantageous properties, such as a better biological action in conjunction with the possibility of a high active ingredient concentration.

Surprisingly, it has been found that this object is achieved by means of the aqueous suspension concentrates of the present invention.

The invention provides an aqueous suspension concentrate comprising

(1) one or more active ingredients from the group of the 4-benzoylpyrazoles,

(2) one or more surfactants based on substituted phenol ethers,

(3) one or more thickeners based on aluminum silicate.

The aqueous suspension concentrate of the invention may further comprise, as additional components, if desired:

(4) additional formulating assistants, and

(5) additional surfactants different from element (2).

The term “aqueous suspension concentrates” refers to suspension concentrates based on water. The proportion of water in the suspension concentrates of the invention can amount to 25-98% by weight in general, 35-85% by weight with preference; in this context, the unit “% by weight” (percent by weight) refers, here and throughout the description, unless otherwise defined, to the relative weight of the respective component, based on the total weight of the formulation.

The active ingredients (component 1) are active ingredients from the group of the 4-benzoylpyrazoles, referred to below as “compounds of the formula (I)” or salts thereof, especially the sodium salts and potassium salts, whose phenyl ring is substituted in positions 2 and 4 by selected radicals; 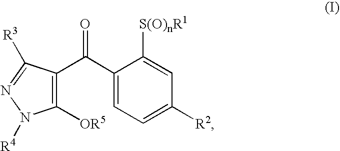
in which
R¹ is methyl or ethyl;
R² is trifluoromethyl or halogen;
R³ is hydrogen, methyl or ethyl;
R⁴ is methyl, ethyl or n-propyl;
R⁵ is hydrogen (C₁-C₆)-alkylcarbonylmethyl, (C₁-C₄)-alkylsulfonyl, phenylsulfonyl, benzyl, benzoylmethyl, (C₁-C₃)-alkylsulfonyl substituted one or more times by halogen, phenylsulfonyl substituted once by methyl or halogen, benzyl substituted by halogen, nitro or methoxy, or benzoylmethyl substituted one or more times by halogen, nitro, methyl or methoxy; and
n is 0, 1, or 2.

Where R⁵ is hydrogen, the compounds of the formula (I) may occur in different tautomeric structures as a function of external conditions, such as solvent and pH.

These structures are known to the skilled worker from WO-A-01/74785 and are also embraced by the claims.

Depending on the nature of the substituents, the compounds of the formula (I) include an acidic proton, which can be removed by reaction with a base. Examples of suitable bases include hydrides, hydroxides and carbonates of lithium, sodium, potassium, magnesium and calcium, and also ammonia and organic amines such as triethylamine and pyridine. Such salts are likewise provided by the invention.

In formula (I) and all subsequent formulae it is possible for alkyl radicals having more than two carbon atoms to be linear or branched. Alkyl radicals are for example methyl, ethyl, n-propyl or isopropyl, n-, iso-, tert- or 2-butyl, pentyls, hexyls, such as n-hexyl, isohexyl and 1,3-dimethylbutyl. Halogen stands for fluorine, chlorine, bromine or iodine. Tosyl stands for 4-methylphenylsulfonyl.

Where a group is substituted multiply by radicals, this means that that group is substituted by one or more identical or different radicals from among those specified.

The compounds of the formula (I) may take the form of stereoisomers, depending on the nature and linkage of the substituents. Where, for example, there are one or more asymmetric carbon atoms present, enantiomers and diastereomers may occur. Stereoisomers can be obtained from the as-prepared mixtures by customary separation methods, such as by chromatographic separation processes, for example. Stereoisomers can also be prepared selectively by employing stereoselective reactions using optically active starting materials and/or auxiliaries. The invention also provides all stereoisomers and mixtures thereof which, while being embraced by the formula (I), have not been specifically defined.

Preference is given to compounds of the formula (I), in which
R¹ is methyl;
R² is trifluoromethyl, fluorine, chlorine or bromine; and
R³ is hydrogen or methyl.

Preference is also given to compounds of the formula (I), in which
R⁴ is methyl or ethyl.

Particular preference is given to compounds of the formula (I), in which
R² is trifluoromethyl and
R⁵ is hydrogen, methylsulfonyl, ethylsulfonyl, n-propylsulfonyl, phenylsulfonyl, 4-methylphenylsulfonyl, benzyl, benzoylmethyl, nitrobenzoylmethyl or 4-fluorobenzoylmethyl.

Very particular preference is given to the compounds of the formula (I), as listed in Table A. The abbreviations used in this table have the following meanings:

| | | | |
|---|---|---|---|
| Bn = benzyl | Bz = benzoyl | Et = ethyl | Me = methyl |
| Pr = propyl | Ph = phenyl | Tos = tosyl | m.p. = melting |
| | | | point |

TABLE A
Compounds of the formula (I), in which the substituents and symbols
have the following definitions:
R¹ = Me R² = CF₃

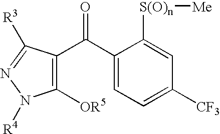

| No. | R³ | R⁴ | R⁵ | n |
|---|---|---|---|---|
| 1 | Me | Me | H | 0 |
| 2 | Me | Me | H | 2 |
| 3 | H | Et | H | 2 |
| 4 | Me | Me | 4-F-Bz-CH₂ | 0 |
| 5 | Me | Me | 4-F-Bz-CH₂ | 2 |
| 6 | Me | Me | Tos | 1 |
| 7 | Me | Et | Bz-CH₂ | 2 |
| 8 | H | Me | H | 2 |
| 9 | H | Et | Tos | 2 |
| 10 | H | Me | Ph-SO₂ | 0 |
| 11 | Me | Me | Ph-SO₂ | 2 |
| 12 | Me | Me | Bz-CH₂ | 0 |
| 13 | Me | Me | Bz-CH₂ | 2 |
| 14 | Me | Me | 4-NO₂-Bz-CH₂ | 2 |
| 15 | Me | Me | 3-NO₂-Bz-CH₂ | 2 |
| 16 | H | Et | Tos | 0 |
| 17 | Me | Me | Tos | 2 |
| 18 | Me | Me | n-Pr-SO₂ | 2 |
| 19 | Me | Me | H | 1 |
| 20 | Me | Et | Ph-SO₂ | 1 |
| 21 | H | Me | Bn | 0 |
| 22 | H | Me | H | 0 |
| 23 | H | Et | Bn | 2 |
| 24 | H | Et | Ph-SO₂ | 2 |
| 25 | H | Et | Me-SO₂ | 0 |
| 26 | Me | Et | Tos | 0 |
| 27 | H | Et | H | 0 |
| 28 | H | Et | H | 1 |
| 29 | Me | Et | H | 2 |
| 30 | Me | Me | Bn | 2 |
| 31 | Me | Me | Et-SO₂ | 0 |
| 32 | Me | Me | Et-SO₂ | 0 |
| 33 | H | Me | Bz-CH₂ | 0 |
| 34 | H | Et | Bz-CH₂ | 2 |
| 35 | Me | Et | Bn | 1 |
| 36 | H | Et | 4-F-Bz-CH₂ | 0 |
| 37 | Me | Me | Me-SO₂ | 2 |
| 38 | Me | Me | n-Pr-SO₂ | 1 |
| 39 | Me | Me | Me-SO₂ | 0 |
| 40 | Me | Et | H | 0 |
| 41 | Me | Me | Tos | 0 |
| 42 | Me | Me | 2-NO₂-Bn | 2 |
| 43 | H | Me | 2-NO₂-Bn | 0 |
| 44 | H | Me | Tos | 0 |
| 45 | Me | Me | n-Pr-SO₂ | 0 |

An especially preferred compound is that numbered 2 in Table A, which is also known to the skilled worker under the common name pyrasulfotole.

The proportion of active ingredients (component 1) in the suspension concentrates of the invention is 0.1%-60%, preferably 1%-55%, more preferably 5%-50% by weight, with the highly concentrated formulations being especially preferred.

The surfactants (component 2) based on substituted phenol ethers are, for example, mono-, di-, and preferably tri-substituted phenols, which may be alkoxylated, e.g. ethoxylated and/or propoxylated and/or butoxylated. In this context the number of alkyleneoxy units can be in the range between 1 and 100, preferably 3-60, more preferably 5-25. Phenol substituents are preferably styryl or isoalkyl radicals. Examples are phenyl(C₁-C₄)alkyl ethers or (poly)alkoxylated phenols [i.e., phenol (poly)alkylene glycol ethers], with, for example 1 to 50 alkyleneoxy units in the (poly)alkyleneoxy moiety, the alkylene moiety containing preferably in each case 2 to 4 carbon atoms, preferably phenyl reacted with 3 to 10 mol of alkylene oxide, (poly)alkylphenols or (poly)alkylphenol alkoxylates [i.e., polyalkylphenol (poly)alkylene glycol ethers], with for example 1 to 12 carbon atoms per alkyl radical and 1 to 150 alkyleneoxy units in the polyalkyleneoxy moiety, preferably triisobutylphenol or tri-n-butylphenol reacted with 1 to 50 mol of ethylene oxide, polyarylphenols or polyarylphenol alkoxylates [i.e., polyarylphenol (poly)alkylene glycol ethers], examples being tristyrylphenol polyalkylene glycol ethers having 1 to 150 alkyleneoxy units in the polyalkyleneoxy moiety, preferably tristyrylphenol reacted with 1 bis 50 mol of ethylene oxide.

Examples of surfactants of this kind are Soprophor® 3D33, Soprophor® BSU, Soprophor® CY/8 (Rhodia) and Hoe® S3474 and in the form of the Sapogenat® T product (Clariant), an example being Sapogenat® T 100.

The fraction of surfactants in the suspension concentrates of the invention is 0.1%-20%, preferably 0.5%-10%, more preferably 1%-7% by weight.

Examples of suitable aluminum silicate-based thickeners (component 3) include those such as hectorites, montmorillonites, saponites, kaolinites, bentonites, attapulgites, etc.

Examples of thickeners of this kind are the Attagels® from Engelhardt Corp., the Bentone® series from Elementis or the Rhodopol® products from Rhodia.

The proportion of aluminum silicate-based thickeners in the suspension concentrates of the invention is 0.01%-5%, preferably 0.1%-3.5% by weight.

Additionally, it is possible for additional formulating assistants to be added to these formulations, such as defoamers, frost preventatives, preservatives, dyes or fertilizers, and also surfactants different from component (2).

The proportion of these formulating assistants in the suspension concentrates of the invention is 0.1%-22%, preferably 0.5%-18%, more preferably 1%-15% by weight.

Suitable defoamers include silicone-based defoamers from Wacker, Rhodia, and Dow Corning, and acetylene-based defoamers, such as those from Air Products, for example.

Examples of suitable frost-preventatives include glycol, propylene glycol, glycerol, and urea.

Examples of suitable preservatives include Acticide® MBS.

Examples of additional surfactants different from component (2) are set out below, in a list in which EO denotes ethylene oxide units, PO propylene oxide units and BO butylene oxide units:
1) C₁-C₂₄-alcohols which may be alkoxylated, for example with 1-60 alkylene oxide units, preferably 1-60 EO and/or 1-30 PO and/or 1-15 BO, in any desired order. The terminal hydroxyl groups of these compounds may be end-capped by an alkyl, cycloalkyl or acyl radical having 1-24 carbon atoms. Examples of such compounds are:
   Genapol®C, L, O, T, UD, UDD, X products from Clariant, Plurafac® and
   Lutensol®A, AT, ON, TO products from BASF, Marlipal®24 and O13 products from Condea, Dehypon® products from Henkel, Ethylan® products from Akzo-Nobel such as Ethylan CD 120.
2) Anionic derivatives of the products described under 1), in the form of ether carboxylates, sulfonates, sulfates and phosphates and their inorganic salts (for example alkali metal and alkaline earth metal salts) and organic salts (for example based on amines or alkanolamines) such as Genapol®LRO, Sandopan® products, Hostaphat/Hordaphos® products from Clariant. Copolymers consisting of EO, PO and/or BO units such as, for example, block copolymers such as the Pluronic® products from BASF and the Synperonic® products from Uniqema with a molecular weight of from 400 to 10⁸. Alkylene oxide adducts of C₁-C₉-alcohols such as Atlox®5000 from Uniqema or Hoe®-S3510 from Clariant.
3) Fatty acid and triglyceride alkoxylates such as the Serdox®NOG products from Condea, or alkoxylated vegetable oils such as soya oil, rapeseed oil, corn oil, sunflower oil, cottonseed oil, linseed oil, coconut oil, palm oil, safflower oil, walnut oil, peanut oil, olive oil or castor oil, in particular rapeseed oil, vegetable oils also being understood as encompassing their transesterification products, for example alkyl esters such as rapeseed oil methyl ester or rapeseed oil ethyl ester, for example the Emulsogen® products from Clariant, salts of aliphatic, cycloaliphatic and olefinic carboxylic acids and polycarboxylic acids, and alpha-sulfo-fatty acid esters such as those available from Henkel.
4) Fatty amide alkoxylates such as the Comperlan® products from Henkel or the Amam® products from Rhodia.
   Alkylene oxide adducts of alkynediols such as the Surfynol® products from Air Products. Sugar derivatives such as amino sugars and amido sugars from Clariant, glucitols from Clariant, alkylpolyglycosides in the form of the APG® products from Henkel or such as sorbitan esters in the form of the Span® or Tween® products from Uniqema or cyclodextrin esters or cyclodextrin ethers from Wacker.
5) Surface-active cellulose and algin, pectin and guar derivatives such as the Tylose® products from Clariant, the Manutex® products from Kelco and guar derivatives from Cesalpina.
   Polyol-based alkylene oxide adducts, such as Polyglykol® products from Clariant. Surface-active polyglycerides and their derivatives from Clariant.
6) Sulfosuccinates, alkanesulfonates, paraffin- and olefinsulfonates such as Netzer IS®, Hoe®S1728, Hostapur®OS, Hostapur®SAS from Clariant, Triton®GR7ME and GR5 from Union Carbide, Empimin® products from Albright and Wilson, Marlon®-PS65 from Condea.
7) Sulfosuccinamates such as the Aerosol® products from Cytec or the Empimin® products from Albright and Wilson.
8) Alkylene oxide adducts of fatty amines, quaternary ammonium compounds having 8 to 22 carbon atoms (C₈-C₂₂) such as, for example, the Genamin®C, L, O, T products from Clariant.
9) Surface-active zwitterionic compounds such as taurides, betaines and sulfobetaines in the form of Tegotain® products from Goldschmidt, Hostapon®T and Arkopon®T products from Clariant.
10) Silicone- or silane-based surface-active compounds such as the Tegopren® products from Goldschmidt and the SE® products from Wacker and also the Bevaloid®, Rhodorsil® and Silcolapse® products from Rhodia (Dow Corning, Reliance, GE, Bayer).
11) Perfluorinated or polyfluorinated surface-active compounds such as Fluowet® products from Clariant, the Bayowet® products from Bayer, the Zonyl® products from DuPont and products of this type from Daikin and Asahi Glass.
12) Surface-active sulfonamides, for example from Bayer.
13) Surface-active polyacrylic and polymethacrylic derivatives such as the Sokalan® products from BASF.
14) Surface-active polyamides such as modified gelatins or derivatized polyaspartic acid from Bayer, and their derivatives.
15) Surfactant polyvinyl compounds such as modified polyvinylpyrrolidone, such as the Luviskol® products from BASF and the Agrimer® products from ISP or the derivatized polyvinyl acetates such as the Mowilith® products from Clariant or the polyvinyl butyrates such as the Lutonal® products from BASF, the Vinnapas® and the Pioloform® products from Wacker or modified polyvinyl alcohols such as the Mowiol® products from Clariant.
16) Surface-active polymers based on maleic anhydride and/or reaction products of maleic anhydride, and copolymers comprising maleic anhydride and/or reaction products of maleic anhydride, such as Agrimer®-VEMA products from ISP.
17) Surface-active derivatives of montan, polyethylene and polypropylene waxes such as the Hoechst® waxes or the Licowet® products from Clariant.
18) Surface-active phosphonates and phosphinates such as Fluowet®-PL from Clariant.
19) Polyhalogenated or perhalogenated surfactants such as, for example, Emulsogen®-1557 from Clariant.
20) Compounds which formally constitute the reaction products of the aforementioned phenols with sulfuric acid or phosphoric acid and their salts which have been neutralized with suitable bases, for example the acid phosphoric ester of triethoxylated phenol, the acid phosphoric ester of a nonylphenol reacted with 9 mol of ethylene oxide, and the triethanolamine-neutralized phosphoric ester of the reaction product of 20 mol of ethylene oxide and 1 mol of tristyrylphenol.
21) Benzenesulfonates such as alkyl- or arylbenzenesulfonates, for example acid (poly)alkyl- and (poly)arylbenzenesulfonates and those neutralized with suitable bases, for example having 1 to 12 carbon atoms per alkyl radical and/or up to 3 styrene units in the polyaryl radical, preferably (linear) dodecylbenzenesulfonic acid and its oil-soluble salts such as, for example, the calcium salt, or the isopropylammonium salt of dodecylbenzenesulfonic acid.

Preferred among the alkyleneoxy units are ethyleneoxy, propyleneoxy and butyleneoxy units, particularly ethyleneoxy units.

Examples of surfactants from the group of the nonaromatic-based surfactants are the surfactants of the above groups 1) to 19), preferably of the groups 1), 2), 6), and 8).

Examples of surfactants from the group of the aromatic-based surfactants are the surfactants of the abovementioned groups 20) and 21), preferably phenol which has been reacted with 4 to 10 mol of ethylene oxide, commercially available for example in the form of the Agrisol® products (Akcros), nonylphenol which has been reacted with 4 to 50 mol of ethylene oxide, commercially available for example in the form of the Arkopal® products (Clariant), tristyrylphenol which has been reacted with 1 to 50 mol of ethylene oxide, for example from the Soprophor® series (Rhodia) such as Soprophor® FL, Soprophor® 4D-384, and acid (linear) dodecylbenzenesulfonate, commercially available for example in the form of the Marlon® products (Hüls).

The suspension concentrates of the invention are produced in a known way (see Winnacker-Küchler, “Chemische Technologie”, volume 7, C. Hanser Verlag Munich, 4th ed. 1986), by means, for example, of wet grinding the components, which can take place in suitable mills, such as in bead mills (discontinuous bead mills, for example, from Drais for example or continuous bead mills, from Bachofen, for example), or colloid mills (such as toothed colloid mills, for example, from Probst+Claasen, for example).

Grinding in this case takes place until 50% of the particles have a size of less than 4 μm (d50≦4 μm), in order to obtain, among other qualities, better storage properties (e.g. no phase separation, sedimentation, etc.).

The invention further provides compositions obtainable from the suspension concentrate of the invention by dilution with liquids, preferably water.

It can be advantageous to add further active ingredients to the compositions obtained in this way, preferably active agrochemical ingredients (e.g., as tank-mix partners in the form of corresponding formulations), and/or auxiliaries and additives which are typical for the application, examples being self-emulsifying oils such as vegetable oils or liquid paraffins and/or fertilizers. The present invention accordingly further provides compositions of this kind, preferably herbicidal compositions, based on the suspension concentrates of the invention.

In this context the term “active agrochemical ingredients” encompasses all substances which are employed in the fields of agriculture, horticulture, forestry, and livestock and also in the domestic sector and in the stored-materials industry. These active agrochemical ingredients include, for example, herbicides, insecticides, acaricides, rodenticides, fungicides, bactericides, nematicides, algicides, molluscicides, viricides, safeners, active resistance-inducing ingredients, active repellent ingredients and active growth regulator ingredients, active ingredients comprising and composed of biological organisms, and fertilizers. Particular preference is given to active ingredients which have a herbicidal, insecticidal, acaricidal, fungicidal, bactericidal, viricidal and growth regulatory activity for a safener activity, very particular preference being given to herbicides, insecticides, fungicides and safeners, and preference among these, in turn, to active herbicidal ingredients.

A particular embodiment of the invention concerns the use of the compositions obtainable from the suspension concentrates of the invention to control unwanted plant growth, referred to below as “herbicidal composition”.

The herbicidal compositions exhibit excellent herbicidal activity against a broad spectrum of economically important monocotyledonous and dicotyledonous weed plants. Even perennial weeds which produce shoots from rhizomes, rootstocks or other perennial organs and are difficult to control are effectively covered. In this context, the herbicidal compositions can be applied, for example, prior to sowing, pre-emergence or post-emergence. Specific examples will be given of some representatives of the monocot and dicot weed flora which can be controlled by the herbicidal compositions, without any intention that the naming of such flora should constitute a restriction to particular species.

Monocotyledonous weed species that are controlled effectively include, for example, Apera spica venti, Avena spp., Alopecurus spp., Brachiaria spp., Digitaria spp., Lolium spp., Echinochloa spp., Panicum spp., Phalaris spp., Poa spp., Setaria spp. and also Bromus spp. such as Bromus catharticus, Bromus secalinus, Bromus erectus, Bromus tectorum and Bromus japonicus, and Cyperus species, from the annuals group, and Agropyron, Cynodon, Imperata and Sorghum and also perennial Cyperus species from the perennials.

In the case of dicotyledonous weed species, the spectrum of action extends to species such as, for example, Abutilon spp., Amaranthus spp., Chenopodium spp., Chrysanthemum spp., Galium spp. such as Galium aparine, lpomoea spp., Kochia spp., Lamium spp., Matricaria spp., Pharbitis spp., Polygonum spp., Sida spp., Sinapis spp., Solanum spp., Stellaria spp., Veronica spp. and Viola spp., Xanthium spp., from among the annuals, and also Convolvulus, Cirsium, Rumex und Artemisia in the case of the perennial weeds.

Weed plants which occur under the specific culturing conditions in rice, such as Echinochloa, Sagittaria, Alisma, Eleocharis, Scirpus and Cyperus, for example, are likewise controlled to outstanding effect by the herbicidal compositions.

Where the herbicidal compositions are applied to the surface of the soil prior to germination, then either the weed seedlings are prevented completely from emerging, or else the weeds grow until they have reached the cotyledon stage, but then stop growing and, finally, after the passage of three to four weeks, die off completely.

When the herbicidal compositions are applied to the green plant parts post-emergence, there is likewise a drastic halt in growth a very short time after the treatment, and the weed plants remain at the growth stage they were in at the time of application, or after a certain time die off completely, so that in this way weed competition, which is harmful for the crop plants, is eliminated in a sustained way at a very early stage.

The herbicidal compositions are notable for a herbicidal action with a rapid onset and long duration. The rainfastness of the active ingredients in the herbicidal compositions is generally favorable. A particular advantage is that the effective dosages of herbicidal compounds that are used in the herbicidal compositions can be set at such a low level that their soil action is optimally low. Hence, not only does it become possible to use them in sensitive crops, but groundwater contamination is virtually avoided. The inventive combination of active ingredients makes it possible to achieve a considerable reduction in the required application rate of the active ingredients.

The aforementioned properties and advantages are of benefit in weed control practice in order to keep agricultural crops free from unwanted plant competition and thus to increase and/or safeguard yields in terms both of quality and quantity. The technical standard is significantly exceeded by these new herbicidal compositions in respect of the properties described.

Although the herbicidal compositions display an excellent herbicidal activity against monocot and dicot weeds, plants of economically significant crops, examples being dicotyledonous crops such as soya beans, cotton, oilseed rape and sugar beet, or gramineous crops such as wheat, barley, rye, oats, millet, rice or maize, are harmed only to an insignificant extent, if at all. For these reasons, the present herbicidal compositions are extremely suitable for the selective control of unwanted plant growth in stands of agricultural crop plants or of ornamentals.

Furthermore, the corresponding herbicidal compositions have outstanding growth-regulatory properties in relation to crop plants. They intervene with regulating effect in the plants' endogenous metabolism and can therefore be employed for the purpose of exerting a targeted influence on plant constituents and of facilitating harvesting, such as by triggering desiccation and stunting of growth, for example. Moreover, they are also suitable for the general control and inhibition of unwanted vegetative growth, without killing the plants in the process. Inhibiting vegetative growth plays a large part for many monocot and dicot crops, since it enables lodging to be prevented completely, or reduced, as a result.

On the basis of their herbicidal and plant growth regulatory properties the herbicidal compositions can also be used to control weed plants in crops of genetically modified plants which are already known or yet to be developed. In general the transgenic plants are distinguished by particular advantageous properties, such as by resistances to certain pesticides, especially to certain herbicides, resistances to plant diseases, or plant-disease pathogens such as certain insects or microorganisms such as fungi, bacteria or viruses. Other particular properties relate, for example to the harvested material, in respect of quantity, quality, storage qualities, composition and specific ingredients. For instance, there are transgenic plants known which feature increased starch content or modified starch quality, and plants featuring a different fatty acid composition of the harvested material.

Preference is given to the use of the herbicidal compositions in economically significant transgenic crops of crop plants and ornamental plants, such as gramineous crops, such as wheat, barley, rye, oats, millet, rice and maize or else crops of sugar beet, cotton, soya bean, oilseed rape, potato, tomato, pea, and other vegetable varieties. The herbicidal compositions can be used with preference in crop-plant crops which are resistant or have been made genetically resistant to the phytotoxic effects of the herbicides.

In the case where the herbicidal compositions are employed in transgenic crops, the effects on weed plants that are observed in other crops are often accompanied by actions which are specific to application in that particular transgenic crop: for example, a modified or specifically extended controllable-weed spectrum, modified application rates that can be used, preferably good possibilities for combination with the additional active herbicidal ingredients to which the transgenic crop is resistant, and effects on growth and yield of the transgenic crop plants.

The present invention accordingly further provides a method of controlling unwanted plant growth, preferably in plant crops such as cereals (e.g. wheat, barley, rye, oats, rice, maize, millet), sugar beet, sugar cane, oilseed rape, cotton and soya beans, more preferably in monocotyledonous crops such as cereals, examples being wheat, barley, rye, oats, hybrids thereof such as triticale, rice, maize, and millet, this method comprising applying the herbicidal compositions of the invention to the weed plants, plant parts, plant seeds or the area on which the plants are growing, e.g. the cultivation area.

The plant crops may also be genetically modified crops or crops obtained by mutation selection, and are preferably tolerant to acetolactate synthase (ALS) inhibitors.

With the suspension concentrates of the invention it is possible to achieve a better biological action at a given application rate. In addition, the high-concentration formulating of active ingredients in the suspension concentrates of the invention enable the associated advantages, such as a reduced level and complexity of packaging, for example, which simplifies the cost and effort involved in production, transport and storage and allows the preparation of the spray mixtures used in agriculture to be dealt with more effectively as a result of the smaller quantities, as for example when dispensing and when stirring.

The suspension concentrates of the invention additionally exhibit, surprisingly, outstanding dispersing and stabilizing properties following further dilution with liquids, preferably water.

Moreover, the suspension concentrates of the invention give rise to formulations which have long-term storage stability and excellent performance properties.

### EXAMPLES

1. Production:

Water is charged to a vessel and pumped in circulation via a colloid mill. Thickeners (e.g. Attagel®; Bentone®) and if desired, formulating assistants are added, followed by the surfactants (e.g. Soprophor®). The final component added is the active ingredient. Thereafter, the entire mixture is transferred via the colloid mill into a further vessel. This mixture is then ground by means of wet grinding using bead mills.

2. Compositions:

TABLE I
Formulation examples 1-8

| | Example: | | | | | | | |
|---|---|---|---|---|---|---|---|---|
| | 1 | 2 | 3 | 4 | 5 | 6 | 7 | 8 |
| Active ingredient | 40 | 48 | 50 | 53 | 55 | 57 | 58 | 60 |
| pyrasulfotole | | | | | | | | |
| Attagel ® 50 | 1 | — | — | — | — | — | — | — |
| Bentone ® EW | — | 0.1 | 0.1 | 0.1 | 0.1 | 0.1 | 0.1 | 0.1 |
| Soprophor ® BSU | 3.0 | 3.1 | 2.8 | 3.0 | 2.7 | 2.7 | 2.9 | 2.9 |
| Soprophor ® 3D33 | 1.5 | 1.3 | 1.4 | 1.2 | 1.1 | 1.6 | 1.2 | 1.3 |
| Soprophor ® CY/8 | 1.0 | 0.7 | 0.8 | 0.6 | 0.6 | 0.9 | 0.8 | 0.7 |
| Water | ad 100 | ad 100 | ad 100 | ad 100 | ad 100 | ad 100 | ad 100 | ad 100 |

All amounts in % by weight

The suspension concentrates of the invention as listed in Table I exhibit the desired properties.

What is claimed is:

1. An aqueous suspension concentrate comprising
(1) one or more active ingredients from the group of the 4-benzoylpyrazoles,
(2) one or more surfactants based on substituted phenol ethers,
(3) one or more thickeners based on aluminum silicate.

2. A suspension concentrate as claimed in claim 1, further comprising additional formulating assistants (component 4).

3. A suspension concentrate as claimed in claim 1, further comprising additional surfactants (component 5) different from component (2).

4. A suspension concentrate as claimed in claim 1, comprising as active ingredient (component 1) compounds of the formula (I) or salts thereof, especially the sodium salts and potassium salts 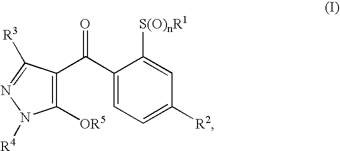
R¹ is methyl or ethyl;
R² is trifluoromethyl or halogen;
R³ is hydrogen, methyl or ethyl;
R⁴ is methyl, ethyl or n-propyl;
R⁵ is hydrogen (C₁-C₆)-alkylcarbonylmethyl, (C₁-C₄)alkylsulfonyl, phenylsulfonyl, benzyl, benzoylmethyl, (C₁-C₃)-alkylsulfonyl substituted one or more times by halogen, phenylsulfonyl substituted once by methyl or halogen, benzyl substituted by halogen, nitro or methoxy, or benzoylmethyl substituted one or more times by halogen, nitro, methyl or methoxy; and
n is 0, 1, or 2.

5. A suspension concentrate as claimed in claim 1, comprising as active ingredient (component 1) compounds of the formula (I), in which
R¹ is methyl;
R² is trifluoromethyl, fluorine, chlorine or bromine; and
R³ is hydrogen or methyl.

6. A suspension concentrate as claimed in claim 1, comprising as active ingredient (component 1) compounds of the formula (I), in which
R⁴ is methyl or ethyl.

7. A suspension concentrate as claimed in claim 1, comprising as active ingredient (component 1) compounds of the formula (I), in which
R² is trifluoromethyl and
R⁵ is hydrogen, methylsulfonyl, ethylsulfonyl, n-propylsulfonyl, phenylsulfonyl, 4-methylphenylsulfonyl, benzyl, benzoylmethyl, nitrobenzoylmethyl or 4-fluorobenzoylmethyl.

8. A suspension concentrate as claimed in claim 1, comprising as active ingredient (component 1) pyrasulfotole.

9. A process for preparing a suspension concentrate as claimed in claim 1, the components being subjected to wet grinding.

10. A composition obtainable from a suspension concentrate as claimed in claim 1 by dilution with liquids, preferably water.

11. A method of controlling unwanted plant growth, which comprises applying a suspension concentrate as claimed in claim 1 or a composition as claimed in claim 10 to the weed plants, plant parts, plant seeds or the area on which the plants are growing.

11. The use of a suspension concentrate as claimed in one or more of claims 1 to 8 or of a composition as claimed in claim 10 to control unwanted plant growth.

12. A method of controlling unwanted plant growth, which comprises applying a suspension concentrate as claimed in one or more of claims 1 to 8 or a composition as claimed in claim 10 to the weed plants, plant parts, plant seeds or the area on which the plants are growing.
